(19) United States
(12) Patent Application Publication
(10) Pub. No.: US 2007/0068386 A1
(43) Pub. Date: Mar. 29, 2007

(54) Landfill gas upgrading process

(76) Inventor: Michael J. Mitariten, Pittstown, NJ (US)

Correspondence Address: Attention: Chief Patent Counsel;ENGELHARD CORPORATION, 101 Wood Avenue, P.O. Box 770, Iselin, NJ, 08830-0770, US

(21) Appl. No.: 11/233,762

(22) Filed: Sep. 23, 2005

(51) Int. Cl. B01D 59/26

(52) U.S. Cl. 95/116

(57) ABSTRACT

A natural gas stream derived from a landfill and containing impurities including siloxane impurities is purified by a PSA process to produce a methane-rich product stream which is substantially free of siloxane impurities. A methane-rich vent stream having a pressure less than the product stream is formed that is also free of siloxanes and can be used as a fuel stream to run a compressor for the PSA process.

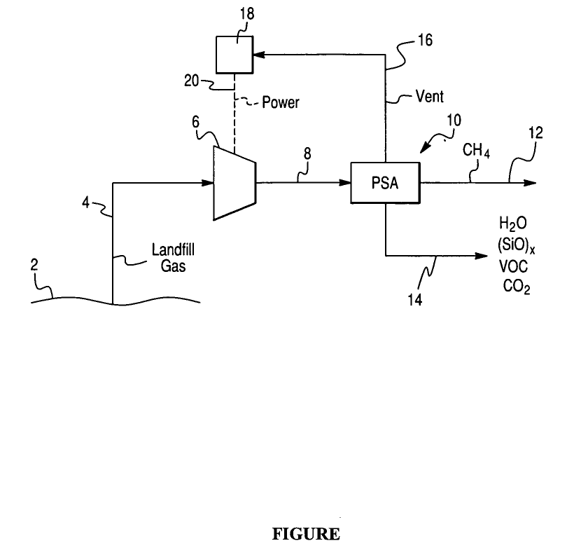

### FIELD OF THE INVENTION

This invention relates to the purification of natural gas from a landfill or other biogas sources. In particular the invention is directed to the removal of impurities such as carbon dioxide, nitrogen, VOC's and siloxanes from the landfill gas. The gas impurities are very common in landfill gas and are removed by a pressure swing adsorption (PSA) process.

### BACKGROUND OF THE INVENTION

Concurrently, the U.S. has proven reserves of natural gas totaling over 150 trillion cubic feet. Recently, annual consumption has exceeded the amount of new reserves that were found. This trend has resulted in higher cost natural gas and may possibly result in supply shortages in the future. As the U.S. reserves are produced and depleted, finding new, clean gas reserves involves more costly exploration efforts. This usually involves off shore exploration, deeper drilling onshore and/or the production of low volume “unconventional” wells all of which are expensive. Moreover, unlike crude oil, it is expensive to liquefy natural gas so that the liquid can be shipped or otherwise transported from areas of production or excess supply and revaporized for local use. Therefore, pricing of natural gas can be expected to rise forcing end users to seek alternative fuels, such as oil and coal, that are not as clean burning as gas. While base consumption for natural gas in the U.S. is projected to grow at 2-3% annually for the next ten years, one segment may grow much more rapidly. Natural gas usage in electric power generation is expected to grow rapidly because natural gas is efficient and cleaner burning allowing utilities to reduce atmospheric emissions. Accordingly, there is a need to develop a cost-effective method of upgrading currently unmarketable sub-quality natural gas reserves in the U.S. thereby increasing the proven natural gas reserve inventory.

When garbage is collected in a sanitary landfill, the decay of the contents leads to the generation of various gases, predominantly methane and carbon dioxide. Landfill gas can also contain nitrogen or air, which is commonly introduced because the landfill gas is collected at low pressure and pulling on the gathering system used to collect the gas can introduce air through various leaks. Upgrading the methane gas from landfills has been widely practiced, most commonly for the production of electric power, but also to produce a high quality synthetic natural gas. The gas composition from a landfill is typically 50% by volume methane. Pipeline requirements call for the removal of carbon dioxide from the landfill gas to a level of roughly 2% by volume. Where, however, direct use as an industrial fuel is possible, landfill gas has been piped to users of such fuel after only relatively minor cleaning.

One of the major concerns with upgrading landfill gas, both for electric power generation or for various fuel consumers, including pipeline gas, is that the landfill gas contains a wide variety of trace components formed during the decay of the contents in the landfill. These components are generally present in the low parts per billion or parts per million ranges and can include various chlorine components among a great number of other volatile organic compounds, VOC's. One of the major concerns with the use of landfill gas is the presence of a variety of siloxanes. The siloxane components are formed during the decay of silicon-containing components in the landfill. When combusted in a gas engine (for example a gas engine driving a generator for the sale of electricity or a gas engine combusting the landfill gas to drive a compressor used to compress the landfill gas), the siloxane components break down on combustion and form a hard silica coating on the internal parts of the gas engine. This coating can reduce engine operation and as well completely disable an engine. For this reason, siloxane components must often be removed before the landfill gas is used as fuel in a gas engine. Processes for removing siloxanes include refrigeration and, therefore, condensation of these relatively high boiling point siloxane components as well as the use of activated carbon beds for the adsorption and removal of the siloxane components, among other removal routes. Once saturated, the carbon beds are removed from the process and a new carbon bed is used. There is no known commercial continuous process of regeneration and reuse of siloxane-saturated beds.

Landfill gas can be upgraded to a higher quality heating value, such as by the removal of carbon dioxide and the removal of nitrogen. Recently, removal of carbon dioxide and nitrogen from natural gas stream can be achieved by a pressure swing adsorption process developed by the present assignee, see U.S. Pat. Nos. 6,610,124; 6,497,750; 6,444,012; 6,315,817; 6,197,092; 6,068,682; 5,989,316. The removal of carbon dioxide from landfill gas has been practiced through a wide variety of technologies including, physical solvents, wherein the carbon dioxide is dissolved in the solvent while methane passes through essentially unaffected, or membrane systems where a compressed landfill gas is passed over a membrane that permits the permeation of the of the carbon dioxide from high pressure to a low permeate pressure, while leaving the methane at high pressure. Other configurations have been used including amine based absorption solvents or multi-stage membrane units, as well as other technologies. All these approaches for the removal of carbon dioxide and/or nitrogen do not address the presence of siloxanes and the disadvantageous consequences thereof as previously discussed. Accordingly, siloxane impurities have required separate pre-treatment processing so that the landfill gas can be used as fuel in gas engines such as for compressing the landfill gas for use as feed to the downstream impurity removal systems.

Another difficulty found with using landfill gas as fuel is that such gas is commonly saturated with water. Industrial fuel users desire the removal of water from the fuel to avoid the possibility of liquid water entering the fuel system of gas engines. Many routes are known for the removal of water from natural gas steams, including glycol dehydration systems or adsorption systems. Regardless of the process used, the dehydration of landfill gas is desirable.

As mentioned above, the present assignee has developed an effective PSA process for the removal of nitrogen from natural gas streams. The process is described in afore-mentioned U.S. Pat. No. 6,197,092, issued Mar. 6, 2001. In general, the process involves a first pressure swing adsorption of the natural gas stream to selectively remove nitrogen and produce a highly concentrated methane product stream. Secondly, the waste gas from the first PSA unit is passed through a second PSA process which contains an adsorbent selective for methane so as to produce a highly concentrated nitrogen product. One important feature of the patented invention is the nitrogen selective adsorbent used in the first PSA unit. This adsorbent is a crystalline titanium silicate molecular sieve also developed by the present assignee. The adsorbent is based on ETS-4 which is described in commonly assigned U.S. Pat. No. 4,938,939. ETS-4 is a novel molecular sieve formed of octrahedrally coordinated titania chains which are linked by tetrahedral silicon oxide units. The ETS-4 and related materials are, accordingly, quite different from the prior art aluminosilicate zeolites which are formed from tetrahedrally coordinated aluminum oxide and silicon oxide units. A nitrogen selective adsorbent useful in the process described in U.S. Pat. No. 6,197,092 is an ETS-4 which has been exchanged with heavier alkaline earth cations, in particular, barium. The barium-exchanged ETS-4 for use in the separation of nitrogen from a mixture of the same with methane is described in commonly assigned U.S. Pat. No. 5,989,316, issued Nov. 23, 1999.

It has also been found by the present assignee that in appropriate cation forms, the pores of ETS-4 can be made to systematically shrink from slightly larger than 4 angstroms to less than 3 angstroms during calcinations, while maintaining substantial sample crystallinity. These pores may be frozen to any intermediate size by ceasing thermal treatment at the appropriate point and returning to ambient temperatures. These materials having controlled pore sizes are referred to as CTS-1 (contracted titano silicate-1) and are described in commonly assigned U.S. Pat. No. 6,068,682, issued May 30, 2000, incorporated herein by reference in its entirety. The CTS-l molecular sieve is particularly effective in separating nitrogen and acid gases selectively from methane as the pores of the CTS-1 molecular sieve can be shrunk to a size to effectively adsorb the smaller nitrogen and carbon dioxide and exclude the larger methane molecule. Reference is made to U.S. Pat. No. 6,315,817 issued Nov. 13, 2001, which also describes a pressure swing adsorption process for removal of nitrogen from a mixture of same with methane and the use of the Ba ETS-4 and CTS-1 molecular sieves. Due to the ability of the ETS-4 compositions, including the CTS-1 molecular sieves to separate gases based on molecular size, these molecular sieves have been referred to as Molecular Gate® sieves.

Afore-mentioned U.S. Pat. No. 6,610,124 discloses removal of nitrogen, CO₂ or both in a PSA process using a CTS-1 adsorbent.

Another unique aspect of the patented Engelhard PSA technology, in particular, for removing impurities from natural gas streams, is that during the PSA process, a co-current recycle step is commonly applied, in which at the end of one or more depressurizing steps, the adsorber vessel that is decreasing in pressure is further depressurized by removing a methane rich stream at low pressure and directing the low pressure stream to a compressor. At the compressor the methane rich steam is increased in pressure and recycled to the feed side of the Engelhard PSA system. The advantage over conventional PSA systems is that the recycled stream allows the overall system to achieve a higher methane recovery rate. When co-current depressurization is complete in the Engelhard PSA process, the vessel is depressurized counter-currently to the direction of the feed, purged with a relatively rich methane stream to remove residual nitrogen and carbon dioxide on the adsorbent and eventually re-pressurized back to near feed pressure using equalization gas in addition to the product or feed gas.

### SUMMARY OF THE INVENTION

In accordance with the present invention, a raw landfill gas containing water, siloxane components, and the many trace components from the landfill, in addition to the common impurities of carbon dioxide along with a level of air is, directed under pressure to a PSA system to remove the impurities and form a methane-rich product stream. The adsorption step is followed by the conventional PSA steps of depressurization for equalization and/or provide purge so as to regenerate the adsorbent. Also, provided is a co-current vent step, in which the adsorber vessel is co-currently depressurized in the direction of the feed gas and an external vent stream is produced from the co-current depressurization process. The vent stream is at a pressure between the high pressure of the feed stream and the low pressure of the purge stream. This vent stream, which has a higher methane concentration than the tail gas and is substantially free of siloxane components, VOC's and water, is used as a clean fuel stream in a gas engine used to provide power in a genset or to drive compressors or for other local uses. In an overall fuel balance, the vent stream with minimal amounts of siloxane components and water roughly supplies the amount of fuel demanded to meet the compression or power requirements of the overall landfill gas purification process. In this simple manner, a clean fuel stream is provided without the additional pretreatment steps commonly practiced to adhere to dehydration and siloxane removal requirements.

### BRIEF DESCRIPTION OF THE DRAWINGS

The FIGURE is a schematic illustration of the landfill gas upgrading process of this invention.

### DETAILED DESCRIPTION OF THE INVENTION

This invention provides a novel process for upgrading landfill gases. The landfill gas is upgraded by using a PSA system. The PSA system is used for siloxane removal, VOC removal, water removal as well as CO₂ and N₂ removal (if required) from the landfill gas.

In order for the PSA process to be effective, the landfill gas needs to be compressed from the initial pressure of the gas derived from the landfill to a higher pressure for use as a feed to an adsorber vessel of the PSA process. The feed pressure to the PSA will typically be about 60-150 psig. At the feed pressure, the impurities in the gas will be adsorbed or trapped by the PSA system. As disclosed previously with respect to prior PSA systems of the assignee, there is provided a vent step, in which the adsorber vessel is co-currently depressurized and an external methane-rich stream at intermediate pressure is produced from the process. However, unlike the previous formation of the external vent stream, the vent gas formed by the process of this invention is substantially free of siloxane components and water and can be used to supply the fuel requirements of the compressor used to bring the landfill gas to PSA feed pressure or for other local fuel uses.

A particularly useful adsorbent for removing the heavy impurities from the landfill gas is a CTS-1 zeolite described and claimed in U.S. Pat. No. 6,068,682, issued May 30, 2000 and assigned to Engelhard Corp. The CTS-1 zeolites are characterized as having a pore size of approximately 2.5-4 Angstrom units and a composition in terms of mole ratios of oxide as follows:
1.0±0.25 M₂ₙO:TiO₂:ySiO₂:zH₂O

wherein M is at least one cation having a valence n, y is from 1.0 to 100 and z is from 0 to 100, said zeolite being characterized by the following X-ray diffraction pattern.

| D-spacings (Angstroms) | I/I.sub.0 |
|---|---|
| 11.3 ± 0.25 | Very Strong |
| 6.6 ± 0.2 | Medium-Strong |
| 4.3 ± 0.15 | Medium-Strong |
| 3.3 ± −.10 | Medium-Strong |
| 2.85 ± 0.05 | Medium-Strong |

wherein very strong equals 100, medium-strong equals 15-80.

The CTS-1 materials are titanium silicates which are different than conventional aluminosilicate zeolites. The titanium silicates useful herein are crystalline materials formed of octahedrally coordinated titania chains which are linked by tetrahedral silica webs. The CTS-l adsorbents are formed by heat treating ETS-4 which is described in afore-mentioned U.S. Pat. No. 4,938,939, and 6,068,682. The CTS-1 zeolite may be formed and used in the present PSA process having a variety of pore sizes ranging from 2.5 angstroms to approximately 4.0 angstroms.

As is known in the PSA art, the zeolite sorbents can be composited or grown in-situ with materials such as clays, silica and/or metal oxides. The latter may be either naturally occurring or in the form of gelatinous precipitates or gels including mixtures of silica and metal oxides. Normally crystalline materials have been incorporated into naturally occurring clays, e.g., bentonite and kaolin, to improve the crush strength of the sorbent under commercial operating conditions. These materials, i.e., clays, oxides, etc., function as binders for the sorbent. It is desirable to provide a sorbent having good physical properties because in a commercial separation process, the zeolite is often subjected to rough handling which tends to break the sorbent down into powder-like materials which cause many problems in processing. These clay binders have been employed for the purpose of improving the strength of the sorbent.

Naturally occurring clays that can be composited with the crystalline zeolites include the smectite and kaolin families, which families include the montmorillonites such as sub-bentonites and the kaolins known commonly as Dixie, McNamee, Georgia and Florida or others in which the main constituent is halloysite, kaolinite, dickite, nacrite or anauxite. Such clays can be used in the raw state as originally mined or initially subjected to calcinations, acid treatment or chemical modification.

In addition to the foregoing materials, the crystalline zeolites may be composited with matrix materials such as silica-alumina, silica-magnesia, silica-zirconia, silica-thoria, silica-berylia, silica-titania as well as ternary compositions such as silica-alumina-thoria, silica-alumina-zirconia, silica-alumina-magnesia and silica-magnesia-zirconia. The matrix can be in the form of a cogel. The relative proportions of finally divided crystalline metal organosilicate and inorganic oxide gel matrix can vary widely with the crystalline organosilicate content ranging from about 5 to about 90 percent by weight and more usually in the range of 90 percent by weight of the composite.

Other adsorbents can be used to remove the impurities from the landfill gas stream. Such additional absorbents can include activated alumina, molecular sieves, carbon molecular sieves, activated carbon or silica such as silica gels. These other adsorbents may be used alone, uniformly mixed with the CTS-1 zeolite adsorbent or provided in separate layers upstream or downstream from the CTS-1 material. It may also be possible to use these other adsorbents in an upstream or downstream adsorbent bed, which is separate from an adsorbent bed, which contains the CTS-1 zeolite. In such a case, however, the costs of additional adsorbent beds plus the costs of pressurizing and depressurizing such adsorbent beds may render the use of separate adsorbent beds containing different adsorbents uneconomical.

The FIGURE illustrates an embodiment of the PSA process of this invention to purify a landfill generated gas stream. In accordance with this invention, a gas stream 4 is extracted from a landfill 2 in a known manner. Modem landfills are typically provided with a gathering system of piping to affect removal of the natural gas that is formed. In general it has been found that landfills soon after formation generate natural gas and that such gas is continuously generated as the landfill grows. The gas stream 4 consists primarily of methane, carbon dioxide, air, water, siloxanes, VOC's, and other trace elements. From the landfill 2, the gas stream is generally gathered at a pressure from sub-atmospheric to 25 psig. This pressure is too low for feed to a PSA process. In accordance with this invention, the landfill gas is pressurized to PSA feed pressure using compressor 6. Compressor 6 increases the pressure of landfill gas stream 4 to about 60 to 200 psig. The compressed landfill gas stream 8 is then directed to the PSA process designated by reference numeral 10. The PSA process 10 will typically contain 2 to 4 adsorbent vessels. Each of the vessels will typically undergo the pressurization, depressurization, equalization, and provide purge steps which are well known in the art and described below. During the adsorption process, the compressed landfill gas stream 8 is put in contact with the adsorbent, such as the CTS-1 zeolite, to remove the impurities from the landfill gas. What leaves the adsorbent vessel is a high pressure methane-rich product stream 12 containing at least about 65 volume % methane. The methane-rich product stream 12 is substantially free from siloxane components, VOC's, water and has a reduced level of carbon dioxide. Nitrogen and some oxygen can also be removed, if required. These impurities are typically adsorbed by the adsorbent or adhered to the surface thereof and are eventually recovered from the adsorbent during a low pressure purge of the adsorbent vessel so as to yield a waste stream 14 which contains concentrations of the impurities which are higher in stream 14 than the landfill gas stream 4 or the compressed landfill gas stream 8 which is directed to the PSA process 10.

Waste stream 14 is produced in the final stages of depressurization and regeneration of the adsorbent in the adsorbent vessel. Typically, a series of depressurization steps are conducted to reduce the pressure of the adsorption vessel and recover the methane gas which may be trapped within the voids of the adsorbent particles. During the depressurization of the adsorbent bed, a depressurization which is co-current with the feed is conducted so as to produce an external vent stream 16. This vent stream 16 has a similar concentration of methane than the compressed feed stream 8 and is at a pressure intermediate that of for stream 8 and the low pressure waste stream 14. The methane-rich vent stream 16 is substantially free of heavy impurities, in particular, siloxane components, and as such, the vent stream 16 is particularly useful as a fuel stream. As shown in the FIGURE, the vent stream 16 can be directed to engine 18 which itself can be used to operate compressor 16 by providing fuel depicted as line 20. Since the vent stream 16 is free of heavy impurities such as siloxane components, the fuel stream can be effectively used in an engine without causing the precipitation of silica during combustion which has been found when siloxane-containing streams have been used for fuel. By utilizing the vent stream 16 as a fuel to provide power to compressor 6, the overall efficiency of the process for removing impurities from a landfill gas is greatly improved. Although not shown, the vent stream 16 itself may be compressed and recycled to line 8 to improve the recovery of methane from the feed stream 8 and produce a product methane stream 12 having a higher recovery of methane. Additionally, the vent stream 16 can be used to provide fuel requirements in any other part of the landfill recovery process. Again, since the vent stream 16 is substantially free of heavy impurities, this fuel can be used effectively and safely to operate power producing equipment without resulting in harmful deposits from the combustion of the fuel stream.

A PSA processes using multi-bed systems is illustrated by Wagner, U.S. Pat. No. 3,430,418, relating to a system having at least four beds. This patent is herein incorporated by reference in its entirety. As is generally known and described in this patent, the PSA process is commonly performed in a cycle of a processing sequence that includes in each bed: (1) higher pressure adsorption with release of product effluent from the product end of the bed; (2) co-current depressurization to intermediate pressure with release of void space gas from the product end thereof; (3) countercurrent depressurization to a lower pressure; (4) purge; and (5) pressurization. The void space gas released during the co-current depressurization step is commonly employed for pressure equalization purposes and to provide purge gas to a bed at its lower desorption pressure. In this invention, a co-current depressurization step can also be used to provide external vent stream 16.

Specific operation of PSA can involve the following steps: adsorption, equalization, co-current depressurization to compression, provide purge, countercurrent depressurization, purge, equalization and pressurization. These steps are well-known to those of ordinary skill in this art. Reference is made to U.S. Pat. Nos. 3,430,418; 3,738,087 and 4,589,888, all of which are herein incorporated by reference, for a discussion of these internal steps of a PSA process. Again referring to the FIGURE, the adsorption process, PSA 10, begins with the impurity adsorption step in which compressed gas stream 8 is fed to a bed containing a particulate adsorbent selective for CO₂, H₂O, VOCs and siloxanes. Adsorption yields a product stream 12 rich in methane, reduced in impurities and at approximately the same operational pressure as feed 8. After the adsorption step, the bed may be co-currently depressurized in a series of steps referred to in the art as equalizations. After the adsorbent bed has completed 1 to 4 optional equalizations, the adsorbent bed can be further co-currently depressurized. The gas leaving the bed during the co-current depressurization, depicted as stream 16 can be used as either fuel, provide purge, recycled back to feed or any combination thereof. As above described, stream 16 provides an effective fuel stream. Stream 16 will have a pressure of 10 to 100 psia, preferably 15 to 60 psia. Subsequently, the bed is counter-currently depressurized, and then purged with gas from the earlier provide purge step. The adsorbent bed is pressurized with gas from earlier equalizations, and finally the bed is pressurized with product gas or alternatively feed gas. These steps are routine, and except for formation and use of the co-current intermediate pressure vent stream 16 to fuel or recycled to feed stream 8 are known in the art. This latter step is unique and has been developed by the present assignee to improve overall process efficiency including improvement in operational costs in nitrogen and/or CO₂ removal from natural gas. By using a co-current vent stream for recycle instead of the typical waste stream recycle, operational energy costs (compression costs) are saved as the vent stream 16 is compressed to PSA 10 feed pressure from a higher pressure than the waste stream. Important to this invention, stream 16 is substantially free of siloxane impurities is especially useful as a fuel stream, in particular, to provide fuel for compression or power for methane recovery from the landfill gas. Subsequent to formation of the vent stream 16, a further depressurization/equalization step to about 20 psia can be performed to recover methane values from void space gas before a final purge to waste gas at low pressure, e.g. 7 psia. Without the further depressurization/equalization, valuable methane gas would be purged to waste 14.

What is claimed is:

1. A process for removing impurities from a natural gas feed stream derived from a landfill comprising; contacting said natural gas feed stream which contains siloxane impurities at a feed pressure with an adsorbent capable of adsorbing or trapping said siloxane impurities, recovering a methane-rich product stream which has a lower concentration of said siloxane impurities than said natural gas feed stream, removing said siloxane impurities from said adsorbent at a pressure lower than said feed pressure to regenerate said adsorbent.

2. The process of claim 1, wherein said natural gas feed stream is at a feed pressure of from 60 to 250 psig.

3. The process of claim 2, comprising gathering a natural gas stream from said landfill at a pressure of from sub-atmospheric to 25 psig and compressing said gathered natural gas stream in a compressor to said feed pressure.

4. The process of claim 3, wherein said methane-rich product stream is at about said feed pressure.

5. The process of claim 1 wherein said adsorbent is in an adsorbent vessel, and further comprising the steps of reducing the pressure of said adsorbent vessel co-current with said natural gas feed stream subsequent to said recovery of said methane-rich product stream, and recovering an additional methane-rich vent stream at a pressure lower than the pressure of said product stream.

6. The process of claim 5 comprising further reducing the pressure of said adsorbent vessel subsequent to formation of said vent stream and recovering a low pressure waste stream comprising a higher concentration of said impurities than said natural gas feed stream.

7. The process of claim 6 wherein said vent stream has a pressure intermediate said methane-rich product stream and said waste stream.

8. The process of claim 6 wherein said vent stream is substantially free of siloxane impurities.

9. The process of claim 3 wherein said adsorbent is in an adsorbent vessel, reducing the pressure of said adsorbent vessel subsequent to said recovery of said methane-rich product stream and a recovering an additional methane-rich vent stream, at a pressure lower than the pressure of said product stream.

10. The process of claim 9 comprising further reducing the pressure of said adsorbent vessel subsequent to formation of said vent stream and recovering a low pressure waste stream comprising a higher concentration of said impurities than said natural gas feed stream.

11. The process of claim 9 wherein said vent stream is used as a fuel stream to operate said compressor.

12. The process of claim 11 wherein said vent stream is substantially free of siloxane impurities.

13. The process of claim 1 wherein said adsorbent comprises CTS-1, activated alumina, activated carbon, silica gels, molecular sieves, carbon molecular sieves or mixtures thereof.

14. The process of claim 13 wherein said adsorbent comprises CTS-1.

15. The process of claim 1 wherein said feed stream further contains carbon dioxide impurities and said methane-rich product stream contains a lower concentration of said carbon dioxide impurities than said feed stream.

16. The process of claim 15 wherein said methane-rich product stream comprises at least 65 volume % methane.

17. The process of claim 1 wherein said feed stream contains water and said methane-rich product stream contains a concentration of water less than said feed stream.

18. The process of claim 16 wherein said feed stream contains water and said methane-rich product stream contains a concentration of water less than said feed stream.

19. The process of claim 17 wherein said feed stream contains VOCs and said methane-rich product stream contains a concentration of VOCs less than said feed stream.

20. The process of claim 5 wherein said vent stream is at a pressure of between 15 and 100 psia.
